(19) United States
(12) Patent Application Publication
(10) Pub. No.: US 2016/0116381 A1
(43) Pub. Date: Apr. 28, 2016

(54) SWAB PORT FOR MICROFLUIDIC DEVICES

(71) Applicant: Ibis Biosciences, Inc., Carlsbad, CA (US)

(72) Inventors: Steven G. Haupt, Carlsbad, CA (US); Steven A. Hofstadler, Carlsbad, CA (US); Thomas N. Chiesl, Carlsbad, CA (US); Bradley J. Sargent, Carlsbad, CA (US)

(21) Appl. No.: 14/921,764

(22) Filed: Oct. 23, 2015

Related U.S. Application Data
(60) Provisional application No. 62/067,767, filed on Oct. 23, 2014.

(51) Int. Cl. G01N 1/10

(52) U.S. Cl. CPC G01N 1/10; G01N 2001/028

(57) ABSTRACT

Provided herein are apparatuses for introducing a liquid over a sample of interest (e.g., a sample on a swab), and related systems and methods utilizing such apparatuses (e.g., microfluidic analyses).

### CROSS-REFERENCE TO RELATED APPLICATIONS

The present Application claims priority to U.S. Provisional Application Ser. No. 62/067,767 filed Oct. 23, 2014, the entirety of which is incorporated by reference herein.

### FIELD OF THE INVENTION

Provided herein are apparatuses for introducing a liquid over a sample of interest (e.g., a sample on a swab), and related systems and methods utilizing such apparatuses (e.g., microfluidic analyses).

### BACKGROUND OF THE INVENTION

Improved integrated systems and apparatuses addressing the problem of how to interface swabs (having a sample of interest thereon) that are traditionally used in forensics, clinical applications, biowarfare, and analysis of explosives with microfluidic devices are needed.

### SUMMARY OF THE INVENTION

Provided herein are apparatuses that combine the primary function of a reagent pack with a sample/swab port. The reagent pack portion of the apparatus (e.g., rupturable packs positioned within a main body; described in more detail below) holds/stores wet reagents in rupturable packs or reservoirs and also contains dried and or lyophilized reagents and all ancillary items to perform a chemical/biochemical analysis of a sample. The reagent pack is designed in such a fashion such that when activated, rupturable packs (e.g., Blister packs) burst and flow into dried reagent reservoirs and the sample/swab port which contains the sample of interest. The reagent pack is a separate modular piece from any of the microfluidic components but is easily integrated with a microfluidic card (e.g., via a peel and place adhesive/alignment strategy).

The apparatuses, systems, kits, and methods provided herein represent significant improvements involving the contacting of a desired fluid to a sample of interest contained on a swab. Indeed, the apparatuses, systems, kits, and methods provided herein solve the problem of how to interface swabs (e.g., having a sample of interest thereon) that are traditionally used in forensics, clinical applications, biowarfare, and analysis of explosives with microfluidic devices. It serves as a mechanism/interface to enable removal of manual labor intensive steps from the benchtop. Moreover, the methods are provided for introducing liquid material over the swab. Samples are not limited to swabs and could be solid, liquid, or powder. Methods are also provided to envelop such samples with liquid prior to microfluidic operation via a described swab port within a main body. Generally, this area has been vastly ignored in the microfluidic community and the apparatuses, systems, kits, and methods provided herein address such needs.

Accordingly, apparatuses are provided for introducing a liquid over a sample of interest (e.g., a sample on a swab), and related systems and methods utilizing such apparatuses (e.g., microfluidic analyses).

In certain embodiments, apparatuses configured for contacting a sample of interest with a fluid within a closed setting (e.g., within a housing) are provided. Such apparatuses are not limited to particular configuration for such function. In some embodiments, the apparatuses have a swab port region configured to receive and contain a portion of a swab having thereon a sample of interest. In some embodiments, the apparatuses have one or more rupturable pack cavities configured to receive and contain one or more rupturable packs (e.g., Blister packs) containing fluid. In some embodiments, the apparatuses further contain spiral channels and straight channels connecting the swab port region and the rupturable pack cavities for purposes of delivering fluid released into the rupturable pack cavity to the swab port region. In some embodiments, the apparatuses further contain one or more ports for releasing the liquid from the apparatus to an external device (e.g., a microfluidic device). In some embodiments, the swab port region has thereon a lid for sealing the swab port region upon receipt of a swab. In some embodiments, the swab port region further contains overflow regions configured to retain excess fluid released through the rupturable pack cavities. In some embodiments, the one or more ports for releasing the liquid from the apparatus to an external device are configured for delivering fluid having been contacted with the swab port region to a microfluidic device (e.g., for further microfluidic analyses). In some embodiments, the apparatus is configured for manual bursting of rupturable packs positioned within the rupturable pack cavities. In some embodiments, the apparatus is configured for automatic bursting of rupturable packs positioned within the rupturable pack cavities.

In some embodiments, the apparatuses have two or more rupturable pack cavities wherein at least two of the rupturable pack cavities contain different fluid reagents that mix upon rupturing of the rupturable pack cavities. In some embodiments, the spiral channels and/or straight channels have therein dry reagents positioned such that upon rupturing of the rupturable pack cavities, the released contents will mix with the dry reagents.

In some embodiments, the swab port region may be used with any type of sample of interest, independent of whether the sample is associated with a swab or independent of a swab. For example, in some embodiments, the swab port region is configured to receive and contain a biological sample, a forensic sample, and/or an environmental sample in any format.

In some embodiments, one or more of the swab port region, rupturable pack cavities, straight channels, and spiral channels contain lyophilized regents.

In some embodiments, the bottom side of the apparatus has thereon a double-sided adhesive. In some embodiments, the apparatus is configured to adhesively engage with an external device via the double-sided adhesive.

In some embodiments, the swab port has therein a filtration membrane.

In some embodiments, the apparatus further contains one or more stirring agents configured to mix liquid released into the apparatus. In some embodiments, the mixing with the stirring agents occurs manually or automatically.

In some embodiments, the apparatus further contains electromagnetic elements.

In some embodiments, the apparatus further contains sonication elements.

In some embodiments, the apparatus further contains heating elements.

In some embodiments, the apparatuses have two or more rupturable pack cavities wherein at least two of the rupturable pack cavities contain different fluid reagents that mix upon rupturing of the rupturable pack cavities. In some embodiments, the spiral channels and/or straight channels have therein dry reagents positioned such that upon rupturing of the rupturable pack cavities, the released contents will mix with the dry reagents.

In certain embodiments, systems for contacting a sample of interest with a fluid within a closed setting (e.g., within a housing) are provided. In some embodiments, the systems have an apparatus (e.g., as described herein) and one or more rupturable packs (e.g., Blister packs) containing a fluid of interest. The rupturable packs are not limited to containing a particular type of fluid. Examples of such fluid include, but are not limited to, lysis buffer, PCR master mix, wash buffer, elution buffer, and de-ionized water. In some embodiments, the fluid is within a suspension having therein, for example, magenetic beads, lysis buffer, PCR master mix, wash buffer, elution buffer, and/or de-ionized water. In some embodiments, the one or more rupturable packs are positioned within the one or more rupturable pack cavities. In some embodiments, the systems further contain a microfluidic device. In some embodiments, the microfluidic device is engaged with the apparatus.

In certain embodiments, methods for contacting a fluid with a sample are provided. In some embodiments, such methods comprise rupturing a rupturable pack containing a fluid positioned within such apparatuses (e.g., as described herein), wherein the rupturing results in a flow of the fluid through the rupturable pack cavity into one or more of the straight and spiral channels and into the swab port region, wherein the flow of fluid into the swab port region results in contact of the fluid with a sample contained on a swab positioned within the swab port region. In some embodiments, the methods further involve releasing the fluid contacted with the sample from the apparatus to a microfluidic device engaged with the apparatus. In some embodiments, the one or more rupturable packs contain one or more fluids selected from lysis buffer, PCR master mix, wash buffer, elution buffer, and de-ionized water.

In certain embodiments, kits for contacting a sample of interest with a fluid within a closed setting (e.g., within a housing) are provided. In some embodiments, the kits contain an apparatus (e.g., as described herein) and one or more rupturable packs (e.g., Blister packs) containing a fluid of interest. In some embodiments, the one or more rupturable packs contain one or more fluids selected from lysis buffer, PCR master mix, wash buffer, elution buffer, and de-ionized water. In some embodiments, the fluid is within a suspension having therein, for example, magenetic beads, lysis buffer, PCR master mix, wash buffer, elution buffer, and/or de-ionized water. In some embodiments, the one or more rupturable packs are positioned within the one or more rupturable pack cavities. In some embodiments, the kits further contain a microfluidic device. In some embodiments, the microfluidic device is engaged with the apparatus.

The apparatus, systems, and kits described herein find use in any type of setting requiring the contacting of a desired liquid with a sample contained on a swab (e.g., a forensic setting, a food safety setting, a medical sampling setting, an environmental setting, a cosmetic setting, and/or an industrial cleaning setting) (e.g., any setting requiring the sterile use of swab having thereon any desired type of fluid). The apparatus, systems, and kits described herein find use in any type of setting requiring the contacting of a desired liquid with a sample contained on a swab for applications involving microfluidics (e.g., a forensic setting, a food safety setting, a medical sampling setting, an environmental setting, a cosmetic setting, and/or an industrial cleaning setting) (e.g., any setting requiring the sterile use of swab having thereon any desired type of fluid).

In some embodiments wherein the setting is a DNA forensic setting, the described apparatuses, systems, and/or kits are used to contact a desired fluid within a rupturable pack (e.g., sterile water) (e.g., DNA buffer (e.g., 10 mM tris-HCl)) with a sample contained on a swab contained within the apparatus (e.g., contained within the swab port), and subsequent delivery to a microfluidic card (e.g., for further microfluidic analyses).

In some embodiments wherein the setting is an environmental setting, the described apparatuses, systems, and/or kits are used to sterilely apply a desired fluid from a rupturable pack (e.g., organic solvent) to a sample contained on a swab contained within the apparatus (e.g., contained within the swab port), and subsequent delivery to a microfluidic card.

In certain embodiments, provided herein are apparatuses for contacting a sample of interest with a fluid within a housing, comprising a port region configured to receive and contain sample of interest and one or more rupturable pack regions configured to receive and contain one or more rupturable packs containing fluid, wherein the apparatus further comprises spiral channels and/or straight channels connecting the swab port region and the rupturable pack regions for purposes of delivering fluid released in the rupturable pack cavity to the port region, wherein the apparatus further comprises one or more ports for releasing the liquid from the apparatus to an external device.

In some embodiments, the sample of interest is a biological sample. In some embodiments, the biological sample is a liquid based biological sample. In some embodiments, biological sample is a solid biological sample. In some embodiments, the biological sample is a mixture of a liquid and solid. In some embodiments, the sample of interest comprises blood or urine.

In some embodiments, the sample of interest is an environmental sample.

In some embodiments, the sample of interest is a forensic sample obtained from a forensic setting.

In some embodiments, the port region has thereon a lid for sealing the swab port region upon receipt of a swab. In some embodiments, the apparatus further comprises overflow regions configured to retain excess fluid released through the rupturable pack regions.

In some embodiments, the apparatus is configured for engagement with a microfluidic device. In some embodiments, the one or more ports for releasing the liquid from the apparatus to an external device are configured for delivering fluid having been contacted with the port region to a microfluidic device. In some embodiments, one or more of the port region, rupturable pack cavities, straight channels, and spiral channels contain lyophilized regents.

In some embodiments, the bottom side of the apparatus has thereon a double-sided adhesive, wherein the apparatus is configured to adhesively engage with an external device via the double-sided adhesive. In some embodiments, the apparatus is engaged with an external device via ultrasonic welding.

In some embodiments, the port has therein a filtration membrane.

In some embodiments, the apparatuses further comprise one or more stirring agents configured to mix liquid released into the apparatus. In some embodiments, the mixing occurs manually or automatically.

In some embodiments, the apparatuses further comprise electromagnetic elements.

In some embodiments, the apparatuses further comprise sonication elements.

In some embodiments, the apparatuses further comprise heating elements.

In some embodiments, the apparatus is configured for automatic bursting of rupturable packs positioned within the rupturable pack regions. In some embodiments, the apparatus is configured for manual bursting of rupturable packs positioned within the rupturable pack regions.

In some embodiments, the one or more rupturable packs contain one or more fluids selected from the group consisting of lysis buffer, PCR master mix, wash buffer, elution buffer, and de-ionized water.

In some embodiments, the apparatuses have two or more rupturable pack cavities wherein at least two of the rupturable pack cavities contain different fluid reagents that mix upon rupturing of the rupturable pack cavities. In some embodiments, the spiral channels and/or straight channels have therein dry reagents positioned such that upon rupturing of the rupturable pack cavities, the released contents will mix with the dry reagents.

Additional embodiments are described herein.

### DESCRIPTION OF THE DRAWINGS

FIG. 1A shows a schematic view of a swab port from a previous design. The swab port with flexible lid is in the bottom right of the card and a separate reagent pack in the center of the card sits on top of the card. Reagents must be pipetted by a user or pumped from the reagent pack into the swab via the on card microfluidics. FIG. 1B shows an embodiment of a design which combines the reagent pack with the swab/sample port to create new sample processing methods.

FIGS. 2, 3A, 3B, 3C, 3D, 4A, and 4B show apparatus embodiments for introducing a liquid over a sample.

FIGS. 5A, 5B, 5C, 5D, 5E, and 5F presents still frame images captured from a video sequence of experiments utilizing the provided apparatuses.

FIGS. 6A, 6B, 6C, 6D, 6E, and 6F presents photographs of some of the components of the provided apparatuses.

FIGS. 7A and 7B shows an additional main body embodiment for an apparatus.

FIGS. 8A and 8B shows a modified top piece configured to fit the iterations of the main body piece shown in FIG. 7B.

FIG. 9A provides top side photographs of the modified top piece described in FIG. 8A. FIG. 9B provides bottom side photographs of the modified top piece described in FIG. 8B.

FIGS. 10A and 10B show injection molded prototypes of the main body with the bottom right straight channel filled with a dark dye.

FIG. 11 provides a photograph of an assembled injection molded prototype of a provided apparatus.

FIG. 12 shows an alternate embodiment for the bottom adhesive described in FIG. 2.

FIG. 13 shows a rupturable pack cavity resembling a press fit collar for receiving a rupturable pack.

FIG. 14 shows application of piercing element through the top and bottom of a rupturable pack.

### DETAILED DESCRIPTION OF THE INVENTION

Provided herein are apparatuses, systems and methods providing a swab port within a reagent pack for a microfluidic device such that a user can take a swab with a sample (e.g. forensic samples, clinical samples, biowarfare agent detection samples, environmental samples, etc.) and then break it off inside the apparatus and simply close the lid to contain the swab and liquid processes encountered.

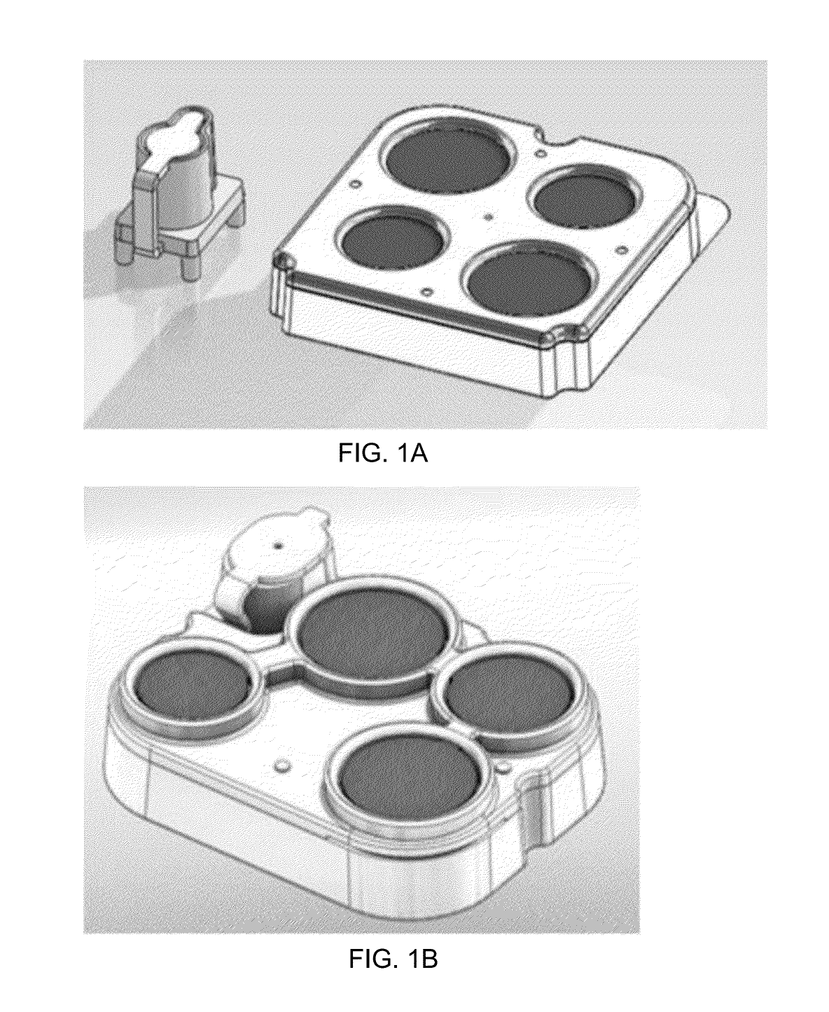

FIG. 1A shows a schematic view of a swab port from a previous design. As shown, the swab port with flexible lid is in the bottom right of the card and a separate reagent pack in the center of the card sits on top of the card. Reagents must be pipetted by a user or pumped from the reagent pack into the swab via the on card microfluidics. A drawback for this design is that the swab port is a separate component from the reagent pack and relies on a user of the microfluidic device to deliver liquid into the swab port chamber.

Provided herein are apparatuses that address and improve over such a design. FIG. 1B shows a schematic view of a provided swab port design wherein the swab port is integrated with the reagent pack. The swab port apparatuses, systems, and methods of the present save device operational time and reduce overall device complexity through integration of the swab port into the reagent pack as shown. There are numerous advantages to the described swab port designs. For example, making one combined piece reduces the fabrication cost of injection molding two separate components followed by assembly of two components. By combining the two components it also creates new opportunities and design concepts not previously disclosed because the total design is linked together. In addition, the provided apparatus designs vastly reduce the microfluidic footprint, plumbing complexity, and time required to pump liquids to desired locations. Such designs can be considered to take the burden of simple fluid movements out of the microfluidics and into the reagent pack. As such, these new concepts and operational methods represent a significant improvement in the art.

Accordingly, provided herein are apparatuses for introducing a liquid over a sample (e.g., a sample on a swab), and related systems and methods utilizing such apparatuses (e.g., microfluidic analyses). The following discussion includes descriptions of the various embodiments of such apparatuses followed by a description of uses of the apparatuses, systems, kits and methods.

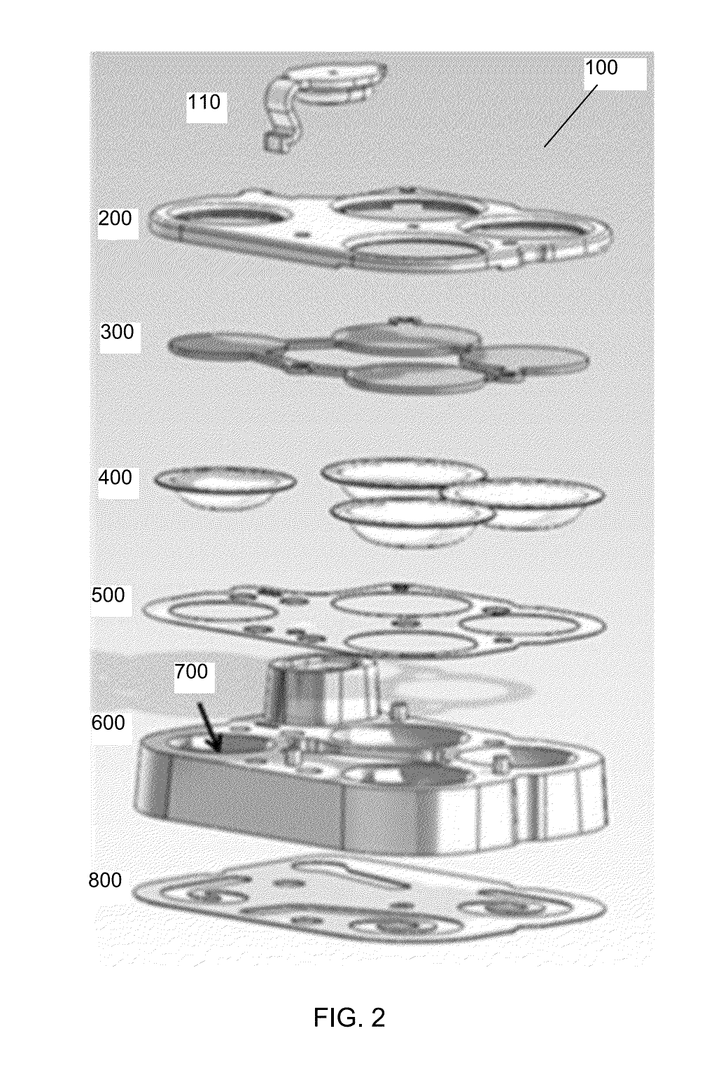

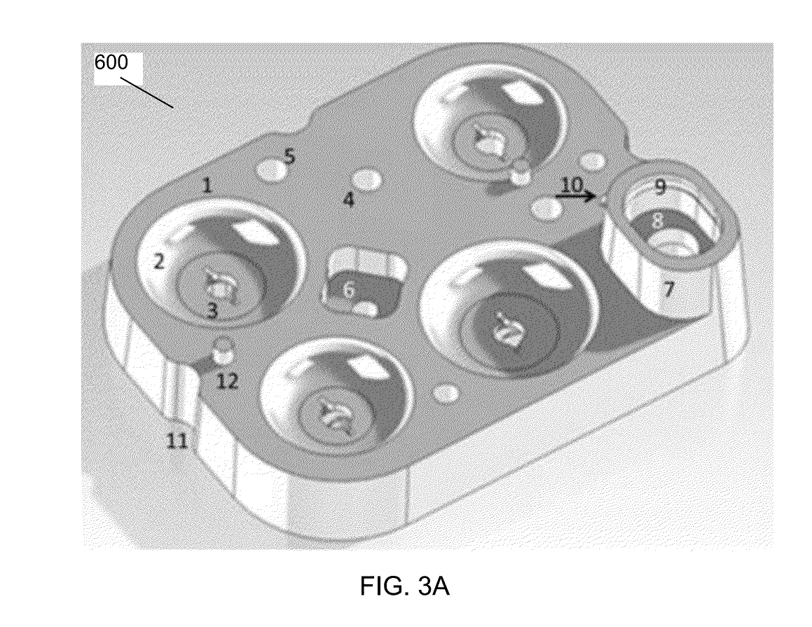

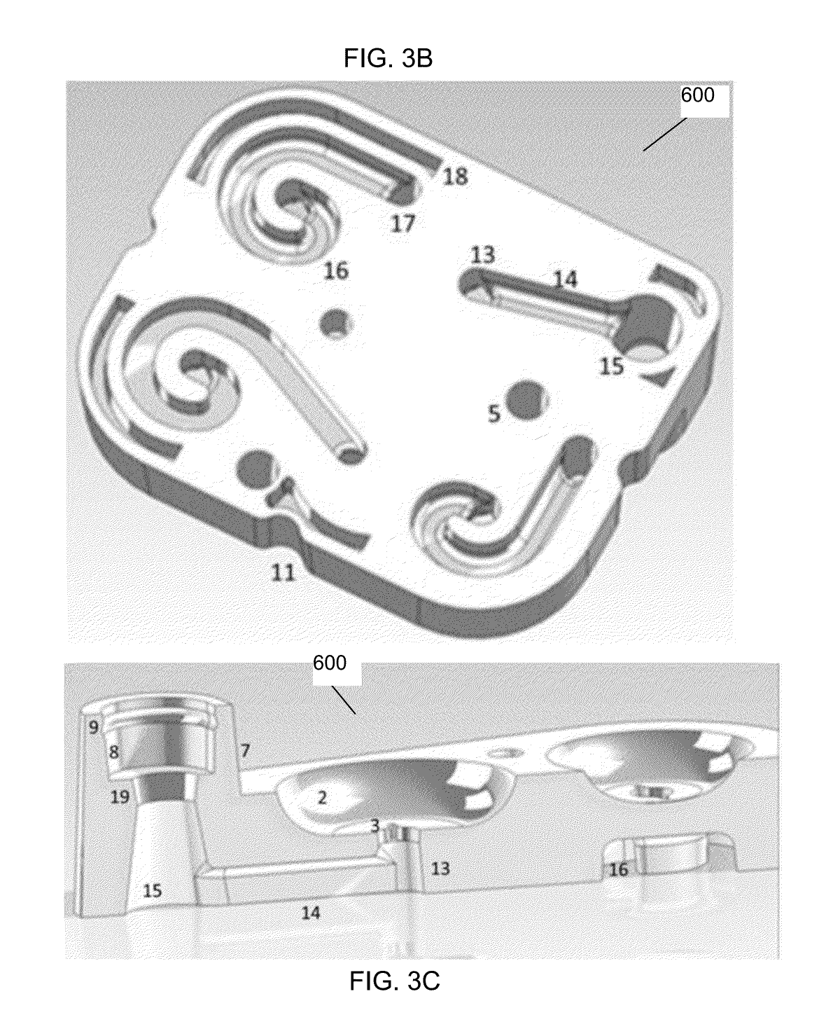

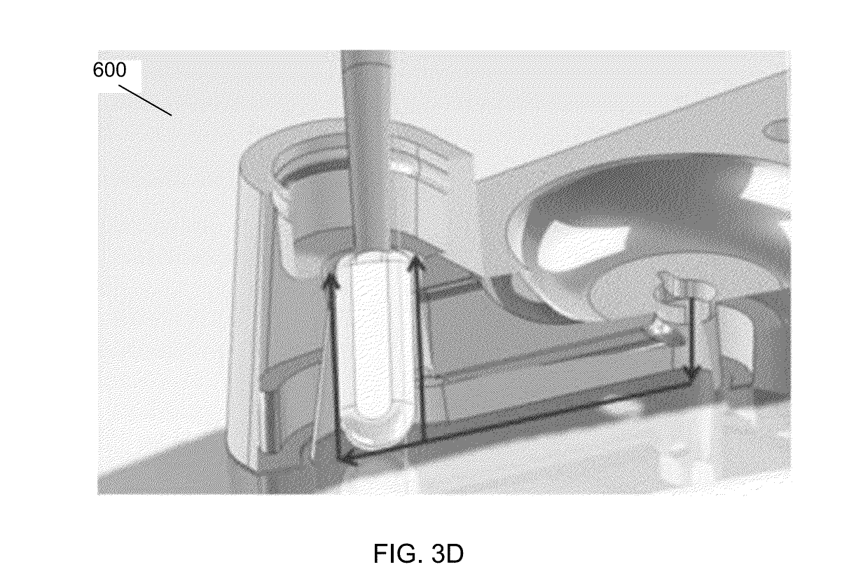

Referring to FIGS. 2 and 3, apparatus embodiments are shown. FIG. 2 shows a side view of the various components of the apparatus 100. As shown in FIG. 2, the apparatus 100 comprises an enclosure 110, a top body piece 200, a gasket 300, rupturable packs 400, a top adhesive layer 500, a main body piece 600, a puncture element 700, and a bottom adhesive layer 800. FIG. 3 shows various viewpoints of the main body piece 600.

Referring to FIG. 2, the apparatus 100 is not limited to particular size dimensions. Indeed, it is contemplated that the apparatus 100 can be provided in numerous sizes depending on the need of a user. In some embodiments, the size of the apparatus 100 is such that it can receive within its interior the end of a swab (e.g., a Bode swab) (e.g., a swab having thereon a sample). In some embodiments, the size of the apparatus 100 is such that it can receive within its interior the end of a swab (e.g., having thereon a sample), can accommodate the “breaking off” of the end of the swab having thereon a sample, and introducing to the swab desired liquid reagents (described in more detail below). In some embodiments, the size of the apparatus 100 is such that it is compatible and/or can be integrated with any type, kind or size of a microfluidics system.

Referring to FIG. 2, the enclosure 110 is used to seal the end of a swab inside the apparatus (e.g., having a sample thereon) (e.g., the end of a swab “broken off” inside the apparatus). The enclosure 110 is not limited to a particular shape and/or design. In some embodiments, the shape and/or design of the enclosure 110 is such that it is able to cover the chamber within the main body 600 for receiving a swab (the swab port; described in more detail below). In some embodiments, the shape and/or design of the enclosure 110 is such that it is able to seal the port within the main body 600 for receiving a swab in an manner preventing spillage of the sample and/or liquid reagents (e.g., upon inadvertent handling of the apparatus). In some embodiments, the enclosure 110 is flexible.

Still referring to FIG. 2, the enclosure 110 is not limited to a particular manner of generating a seal with the port within the main body 600 for receiving a swab. In some embodiments as shown in FIG. 2, the enclosure 110 has thereon a hinge to connect with the main body 600 thereby permitting the enclosure 110 to open and close (e.g., generate a seal) with the main body 600 via a hinge based mechanism. In some embodiments as shown in FIG. 2, the enclosure 110 has a beveled portion configured to fit within the port within the main body 600 for receiving a swab (e.g., fit within the swab port such that a seal is generated that prevents spillage of the sample and/or liquid reagents). In some embodiments, the enclosure 110 has a threaded portion configured to mate with a threaded portion of the port within the main body 600 for receiving a swab (e.g., mate with the port such that a seal is generated that prevents spillage of the sample and/or liquid reagents).

Still referring to FIG. 2, the enclosure 110 is not limited to a particular material composition (e.g., plastic, rubber, metal, Kevlar, carbon, clear polystyrene, etc.). In some embodiments, the material composition of the enclosure 110 is plastic.

Referring to FIG. 2, the top body piece 200 engages with the main body 600 and serves as a frame to secure the gasket 300, rupturable packs 400, and top adhesive layer 500 with the main body 600. The top body piece 200 further serves as a barrier to protect the rupturable packs 400 and further serves as an attachment framework for the gasket 300.

Still referring to FIG. 2, the design of the top body piece 200 is configured such that it matches the top face of main body 600. The top body piece 200 is not limited to a particular thickness. In some embodiments, the thickness of the top body piece 200 is such that it is able to engage with the main body 600 and secure the components inbetween the main body 600 and the top body piece 200 (e.g., the gasket 300, rupturable packs 400, and top adhesive layer 500).

Still referring to FIG. 2, the top body piece 200 is not limited to a particular manner of engaging with the main body 600. In some embodiments, the top body piece 200 engages with the main body 600 via an adhesive seal. Indeed, in some embodiments, a seal is generated between the top body piece 200 and the main body 600 via the top adhesive layer 500. In some embodiments, the top body piece 200 engages the main body 600 through fitting within the main body 600. In some embodiments, the top body piece 200 is configured to engage with the main body 600 via one or more screw based mechanisms.

Still referring to FIG. 2, the top body piece 200 is not limited to a particular material composition (e.g., plastic, rubber, metal, Kevlar, carbon, clear polystyrene, etc.). In some embodiments, the material composition of the top body piece 200 is plastic. In some embodiments, the material composition of the top body piece 200 is clear polystyrene.

Still referring to FIG. 2, the gasket 300 engages with the top body piece 200 and serves as a protective cover for the rupturable packs 400 (to prevent accidental puncturing of the rupturable packs). In addition, the gasket 300 serves to create a liquid tight seal between the rupturable packs 400 and the top body piece 200 thereby preventing undesired spillage of liquid within the rupturable packs 400. In some embodiments, the gasket 300 is flexible.

Still referring to FIG. 2, the design of the gasket 300 is such that it matches the positions within the main body 600 wherein the rupturable packs 400 are positioned. The gasket 300 is not limited to a particular thickness. In some embodiments, the thickness of the gasket 300 is such that it is able to serve as a protective cover for the rupturable packs 400 and to create a liquid tight seal between the rupturable packs 400 and the top body piece 300.

Still referring to FIG. 2, the top body piece 200 is not limited to a particular manner of engaging with the main body 600. In some embodiments, the top body piece 200 engages the main body 600 through fitting within the main body 600. In some embodiments, the top body piece 200 is configured to engage with the main body 600 via one or more screw based mechanisms.

Still referring to FIG. 2, the gasket 300 is not limited to a particular material composition (e.g., plastic, rubber, metal, Kevlar, carbon, clear polystyrene, etc.). In some embodiments, the material composition of the gasket 300 is plastic. In some embodiments, the material composition of the gasket 300 is rubber.

Still referring to FIG. 2, the rupturable packs 400 are positioned within the main body 600 and are covered by the gasket 300. The rupturable packs 400 are not limited to a particular manner of positioning within the main body 600. In some embodiments, the rupturable packs 400 are positioned within pre-formed wells within the main body 600 (described in more detail below). Examples of rupturable packs 400 include blister packs (iSTAT rupturable packs (Abbot) or similar types of rupturable packs)) and liquid gel caps.

Still referring to FIG. 2, in some embodiments, the rupturable packs 400 are configured to receive and contain any desired liquid. For example, in some embodiments, the liquid contained within the rupturable packs 400 is any desired liquid based reagent (e.g., lysis buffer, PCR master mix, wash buffer, elution buffer, de-ionized water, etc.). In some embodiments, the liquid is within a suspension having therein, for example, magenetic beads, lysis buffer, PCR master mix, wash buffer, elution buffer, and/or de-ionized water. The rupturable packs 400 are not limited to containing a particular amount of fluid. In some embodiments, the rupturable packs 400 are configured to contain approximately 500 μl of fluid (e.g., 100 μl, 200 μl, 300 μl, 400 μl, 450 μl, 500 μl, 525 μl, 550 μl, 575 μl, 600 μl, 800 μl, 900 μl, 1000 μl, 5000 μl, 10000 μl, etc.). In some embodiments, the rupturable packs 400 contain dried/lyophilized reagents. In some embodiments, different reagents are containted in different rupturable packs 400.

Still referring to FIG. 2, the rupturable packs 400 are further configured to be rupturable (e.g., puncturable) for purposes of releasing its liquid contents (e.g., releasing its liquid contents into the main body 600 (described in more detail below)).

Still referring to FIG. 2, the rupturable packs 400 are not limited to a particular size and/or design. In some embodiments, the size and design of the rupturable packs 400 are such that they are able to be fitted within pre-formed wells within the main body 600 (rupturable pack cavities; described in more detail below). In some embodiments, the rupturable packs 400 have a concave shape such that a liquid can be received and contained within. As noted, the gasket 300 serves as a covering for the rupturable packs 400 thereby sealing the contained liquid.

Still referring to FIG. 2, the rupturable packs 400 are not limited to a particular material composition (e.g., plastic, rubber, metal, Kevlar, carbon, clear polystyrene, film, etc.). In some embodiments, the material composition of the rupturable packs 400 is puncturable plastic. In some embodiments, the material composition of the rupturable packs 400 is puncturable rubber. In some embodiments, the material composition of the rupturable packs 400 is aluminum with a polymer liner that seals under heat and pressure.

As described in more detail below, the provided apparatuses become activated upon rupturing of the rupturable pacts (e.g., blister packs) positioned within the main body. In some embodiments, such rupturing occurs manually. In some embodiments, the apparatus is configured to automatically rupture the rupturable packs positioned within the main body. As described below, channels exist within the main body which direct liquid released from ruptured rupturable packs into the swab port or dried reagent reservoirs. Such rupture and direction of fluid occurs very rapidly (<5 seconds) and requires no further external or microfluidic actuation to engulf the sample with liquid. The same rupturing mechanism could be applied to wet and or rehydrate a dry reagent (e.g., such as a lyophilized reagent). Rupturable packs can be ruptured simultaneously or independently to control the timing of when individual sample or dried reagent reservoirs are hydrated.

Referring to FIG. 2, the top adhesive layer 500 serves to seal the rupturable packs 400 and the top body piece 200 with the main body 600. The design of the top adhesive layer 500 is such that it matches the top face of main body 600 and the bottom face of the top body piece 200. In some embodiments, the top adhesive layer 500 is configured with a two-sided adhesive such that upon positioning between the top body piece 200 and the main body 600, the top adhesive layer 500 adheres with the bottom face of the top body piece 200 and the top face of the main body 600. The top adhesive layer 500 is not limited to a particular type or kind of adhesive.

Still referring to FIG. 2, the main body 600 engages with the top body piece 200 via the top adhesive layer 500, is configured to receive and contain the rupturable packs 400, and is configured to engage with a microfluidics device via the bottom adhesive layer 800. FIGS. 3A, 3B, 3C and 3D show alternate viewpoints of the main body 600.

Referring to FIGS. 2, 3A, 3B, 3C, and 3D, in some embodiments, the main body 600 is a single injection molded piece. The main body 600 is not limited to a material composition (e.g., plastic, rubber, metal, Kevlar, carbon, clear polystyrene, etc.). In some embodiments, the material composition of the top body piece 200 is a plastic. In some embodiments, the material composition of the top body piece 200 is a metal. In some embodiments, the material composition of the top body piece 200 is clear polystyrene.

Referring to FIG. 3A, the main body 600 is shown from a top-down perspective. As shown, the main body 600 has rupturable pack cavities 2, puncture element sockets 3, rupturable pack overflow ports 4, reagent cavities 5, waste cavities 6, a swab port 7, a swab port overflow 8, a ridged element 9, an enclosure attachment point 10, external alignment regions 11, and internal alignment regions 12.

Referring to FIG. 3A, each of the rupturable pack cavities 2 are configured to receive a rupturable pack cavity. In some embodiments, the rupturable pack cavities 2 are well-shaped so as to accommodate the shape of the rupturable packs. The rupturable pack cavities 2 are not limited to particular size dimensions. In some embodiments, the depth of each rupturable pack cavity 2 is such that it is able to receive a rupturable pack and upon application of an external pressure to the rupturable pack (e.g., a top-downward pressure) engage the bottom of the rupturable pack with bottom of the rupturable pack cavity 2 (e.g., wherein the rupturable pack engages with a puncture element (described in more detail below)). The main body 600 is not limited to a particular number of rupturable pack cavities 2 (e.g., 1, 2, 3, 4, 5, 6, 7, 8, 9, 10, 15, 20, 100, etc.). In some embodiments, as shown in FIGS. 2 and 3A, there are four rupturable pack cavities 2.

Referring to FIGS. 2 and 3A, each of the rupturable pack cavities 2 have within its base a puncture element socket 3. The puncture element socket 3 serves as an attachment region for a puncture element 700 (shown in FIG. 2). The main body 600 is not limited to a particular size for the puncture element sockets 3. In some embodiments, the puncture element sockets 3 are indented regions within the rupturable pack cavities 2 configured to receive and secure a puncture element 700. The size of the puncture element sockets 3 are such that each can receive and secure a puncture element 700 in a manner preventing the accidental puncturing of a rupturable pack positioned within the rupturable pack cavity 2. In some embodiments, the rupturable pack cavity 2 has therein within its base an opening thereby permitting fluid released into the rupturable pack cavity 2 to drain into one or more channels (a channel directed toward the swab port 7 and/or a channel directed toward the rupturable pack overflow port 4; described in more detail below).

Still referring to FIGS. 2 and 3A, the main body is not limited to a particular type or kind or size of the puncture element 700. In some embodiments, the design of the puncture element 700 is such that it can fit and be secured within a puncture element socket 3. In some embodiments, the puncture element 700 is barbed such that upon application of a downward force to a rupturable pack 400 positioned within a rupturable pack cavity 2, the rupturable pack 400 engages the puncture element 700 resulting in the puncturing of the rupturable pack 400 and release of its liquid contents into the rupturable pack cavity 2.

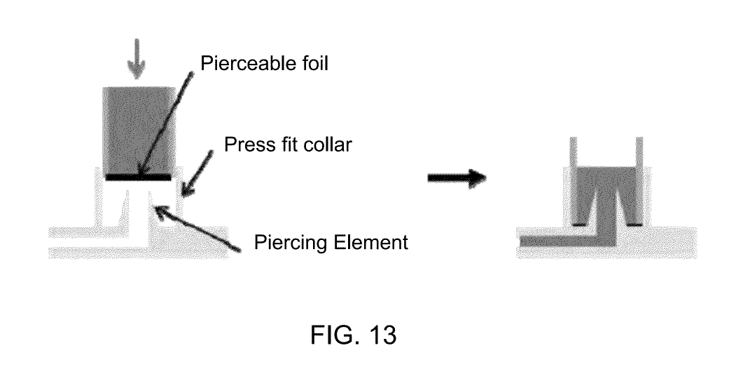

In some embodiments, the rupturable pack cavity has therein a puncture element configured to puncture a rupturable pack positioned within the rupturable pack cavity. Such embodiments are not limited to a particular type or kind or size of a puncture element. In some embodiments, the rupturable pack cavity has within its base a barbed element that protrudes upwards. In such embodiments, upon positioning of a rupturable pack within the rupturable pack cavity, application of a downward pressure onto the rupturable pack results in its engagement with the barbed element which thereby results in a puncturing of the rupturable pack and the release of its liquid contents into the rupturable pack cavity. In some embodiments, the shape of the rupturable pack cavity resembles a press fit collar for receiving a rupturable pack (see, FIG. 13).

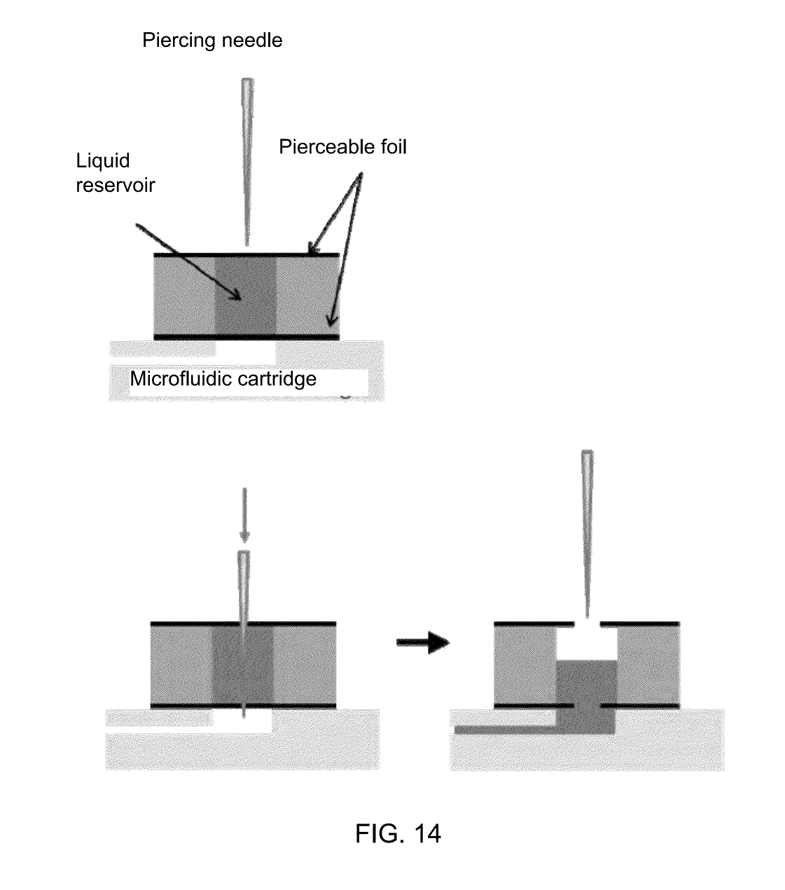

In some embodiments, the rupturable packs are configured such that application of a downward pressure from a puncturing element (e.g., separate needles aligned with the respective rupturable packs) results in the piercing of the top portion of the respective rupturable packs and the bottom portions of the respective rupturable packs, thereby releasing the contents of the rupturable packs into the main body. In some embodiments, such techniques for piercing the rupturable packs (e.g., via downpress pressure of a needle) occur either automatically or manually (see, FIG. 14).

Referring to FIG. 3A, the rupturable pack overflow port 4 serves as region to receive excess liquid released through the rupturable pack cavity 2. In some embodiments, the rupturable pack overflow port 4 and the rupturable pack cavity 2 are connected via a channel. The rupturable pack overflow port 4 is not limited to a particular size. In some embodiments, the rupturable pack overflow port 4 is sized such that it can accommodate any amount of excess liquid released through the rupturable pack cavity 4 that cannot be accommodated within the swab port 7 thereby preventing spillage. The main body is not limited to having a particular number of rupturable pack overflow ports 4. In some embodiments, each rupturable pack cavity 2 is associated with a rupturable pack overflow port 4.

Still referring to FIG. 3A, the reagent cavities 5 serve as a region to accommodate any desired kind or type or amount of reagent (e.g., dry reagent) (e.g., liquid reagent). In some embodiments, the regent cavities 5 are connected with other regions of the main body 600 via different channels. The main body 600 is not limited to having a particular number of reagent cavities 5 (e.g., 1, 2, 3, 4, 5, 6, 10, 15, 20, etc.). In some embodiments, the main body 600 has one reagent cavity 5.

Still referring to FIG. 3A, the waste cavities 6 serve as a reservoir for waste collected within the release of fluids through the rupturable pack cavities 2, the sample contained within the swab port 7, and the reagent cavities 5. The waste cavities 6 are not limited to a particular size. In some embodiments, the waste cavities 6 are sized to accommodate any and all types of waste accumulated within the main body 600. In some embodiments, the waste cavities 6 are connected with other regions of the main body 600 via different channels. The main body 600 is not limited to a particular number of waste cavities 6 (e.g., 1, 2, 3, 4, 5, 6, 10, 15, 20, etc.). In some embodiments, there is one waste cavity 6.

Still referring to FIG. 3A, the swab port 7 serves as a region for receiving and securing the end of an elongated swab (e.g., the end of a SecurSwab (Bode Technology)). The swab port 7 is not limited to a particular size. In some embodiments, the size of the swab port 7 is such that it is able to receive the sample containing end of an elongated swab such that the enclosure 110 is able to close thereby securing the swab within the swab port 7. In some embodiments, the size of the swab port 7 is such that it is able to receive the sample containing end of an elongated swab in a manner permitting the “breaking off” of the sample containing end of the elongated swab thereby depositing the sample containing end of the swab into the swab port. For example, in some embodiments, the depth of the swab port 110 is such that a lateral application of force to the elongated swab results in the “breaking off” of the end of the swab positioned within the swab port 110. In some embodiments, the swab port 7 has an opening within its base permitting introduction of liquid released through a rupturable pack cavity 2 with the swab contained within the swab port 7 (e.g., via different channels).

The swab port region may be used with any type of sample of interest, independent of whether the sample is associated with a swab or independent of a swab. For example, in some embodiments, the swab port region is configured to receive and contain a biological sample, a forensic sample, and/or an environmental sample in any format.

Still referring to FIG. 3A, the swab port overflow 8 serves as a region to collect excess materials (e.g., fluid) within the swab port 7 thereby preventing spillage. In some embodiments, the size of the swab port overflow 8 is such that it is able to accommodate any and all excess material (e.g., fluid) within the swab port 7.

Referring to FIGS. 2 and 3A, the ridged element 9 serves as a region designed to receive the enclosure 110 upon securing with the main body 600. In some embodiments, the shape of the ridged element 9 is such that it accommodates the enclosure 110 in a sealed manner.

Still referring to FIGS. 2 and 3A, the enclosure attachment point 10 serves as a region upon which the enclosure 110 can attach thereby permitting the opening and closing of the enclosure 110.

Still referring to FIG. 3A, the external alignment regions 11 and the internal alignment regions 12 serve as regions for attachment with other parts of the apparatus and/or an external microfluidic device.

FIG. 3B shows the bottom face of the main body 600. As shown, the bottom face of the main body 600 has via holes 13, a straight channel 14, a specialized cavity 15, spiral fluidic channels 16, channel output via holes 17, and shell features 18.

Still referring to FIG. 3B, the via holes 13 serve as a connection with the rupturable pack cavities. The via holes 13 are not limited to particular size dimensions. In some embodiments, the via holes 13 are sized to accommodate liquid flowing through the rupturable pack cavities.

Still referring to FIG. 3B, the straight channel 14 serves as a connection between the via holes 13 and the swab port. The main body is not limited to a particular size of the straight channel 14. In some embodiments, the size of the straight channel 14 is such that it is able to accommodate and transport liquid flowing through the via holes 13 to the swab port.

Still referring to FIG. 3B, the specialized cavity 15 serves as a cavity within the swab port. The specialized cavity 15 is not limited to a particular size.

Still referring to FIG. 3B, the spiral fluidic channels 16 serve to accommodate liquid. The main body is not limited to a particular number of spiral fluidic channels 16 (e.g., 1, 2, 3, 4, 5, 10, etc.). In some embodiments, the main body 600 has three spiral fluidic channels 16.

In some embodiments, the straight channels and/or the spiral fluidic channels have therein dried reagents.

Still referring to FIG. 3B, the channel output via holes 17 serve as a connection with the blister overflow output port.

Still referring to FIG. 3B, the shell features 18 serve as features for injection molding purposes.

FIG. 3C shows a cross-section view of the main body 600. As shown, this perspective of the main body 600 shows the swab port overflow 8, the ridged element 9, the swab port 7, the rupturable pack cavities 2, puncture element sockets 3, via holes 13, a straight channel 14, a specialized cavity 15, spiral fluidic channels 16, and a swab port necking feature 19.

As shown, FIG. 3C shows the fluid path from a ruptured rupturable pack into a sample/swab port. As the blister gets pushed into the cavity space 2 it comes into contact with the puncture element (not shown) that is positioned within the puncture element socket 3. The liquid squirts out of the blister and flows through the via hole 13 and down a straight connecting channel 14 into the specialized cavity 15. The liquid continues to flow upwards through the swab port necking feature 19 and finally into the swab port overflow 8. The swab port necking feature 19 is used as a fulcrum to snap the stick end of a swab (e.g., SecurSwab (Bode Technology)) off and leave only the swab end in the apparatus. The ridged element 9 shows where the lid encloses the sample port. The liquid is able to overcome gravity/siphoning effects and continue to flow up the reservoir because the gasket piece (FIG. 2) has pressure applied to it during the bursting process and effectively seals the source end against backflow.

FIG. 3D shows a swab inserted into the swab port wherein the arrows indicate direction of fluid flow from the bursted blisters during implementation.

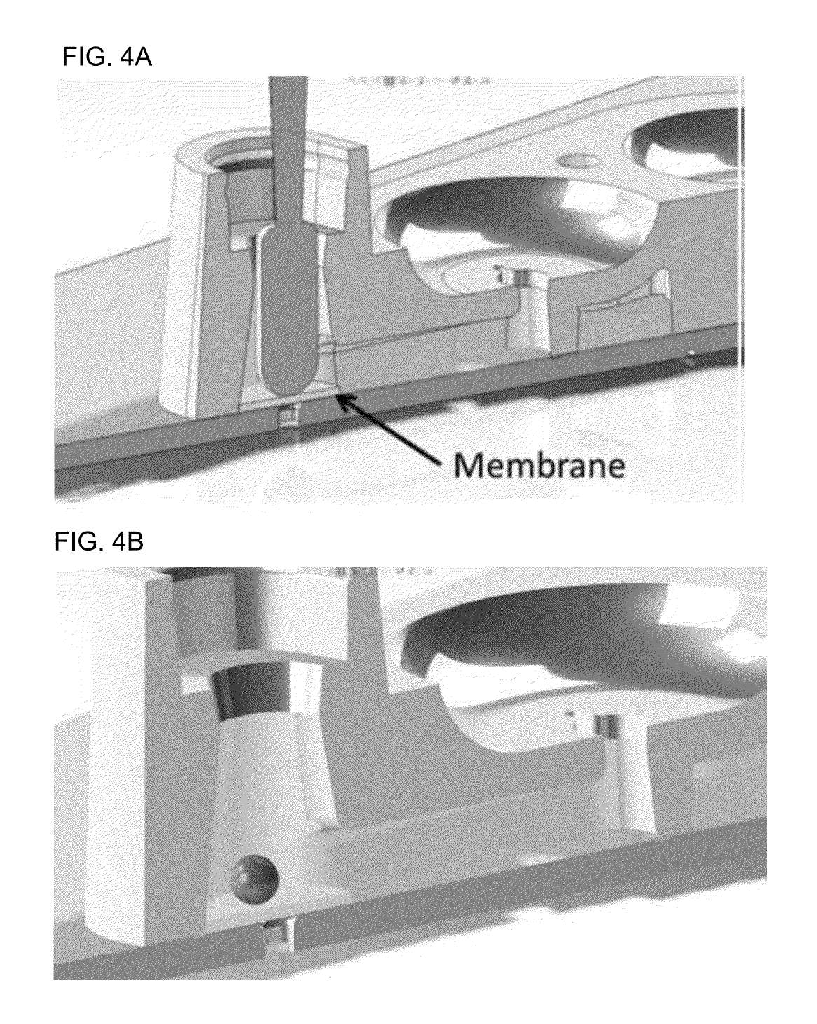

The apparatuses are not limited to a particular use or function for the swab port. In some embodiments, the swab port is designed for receiving and containing the end of a swab (e.g., SecurSwab (Bode Technology)). In some embodiments, the swab port can contain a lyophilized reagent to become rehydrated (e.g., lysis buffer, PCR master mix, buffer salts). In some embodiments, the swab port can be designed as both a swab entry port and also for containing a dried or lyophilized reagent (e.g., dried lysis buffer components that becomes hydrated at the same time the sample swab becomes hydrated). In some embodiments, the swab port can also be smaller such that it contains only the space for the end of a swab and a membrane (e.g., for particulate or cell filtration or membranes designed for DNA purification). For example, in some embodiments, membranes may also be placed inside the swab port to act as filtration devices from the macroscopic sample into the microfluidic device (see, FIG. 4). For example, as shown in FIG. 4A, the depicted membrane could act as a simple filtration membrane to keep particulate from entering the microfluidic device and/or, as shown in FIG. 4B, the membrane could have a chemical functionality (e.g., lyophilized bead of reagent) (e.g., intrinsic material or C6 or C18) to remove grease and oil from sample swab before entering the microfluidic device. In some embodiments, the membrane is relatively thin and does not block the flow from the rupturable pack area into the swab port area.

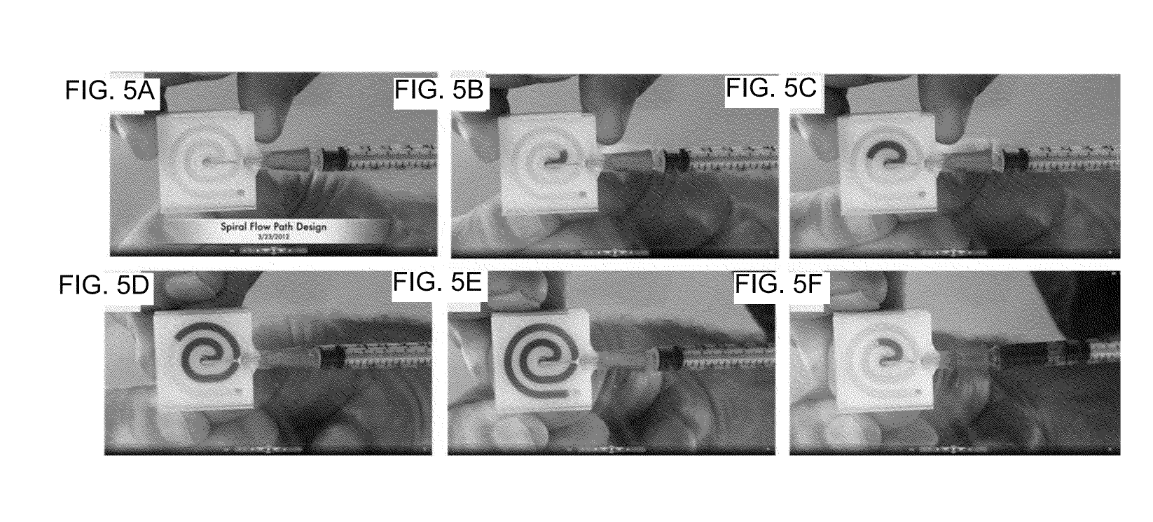

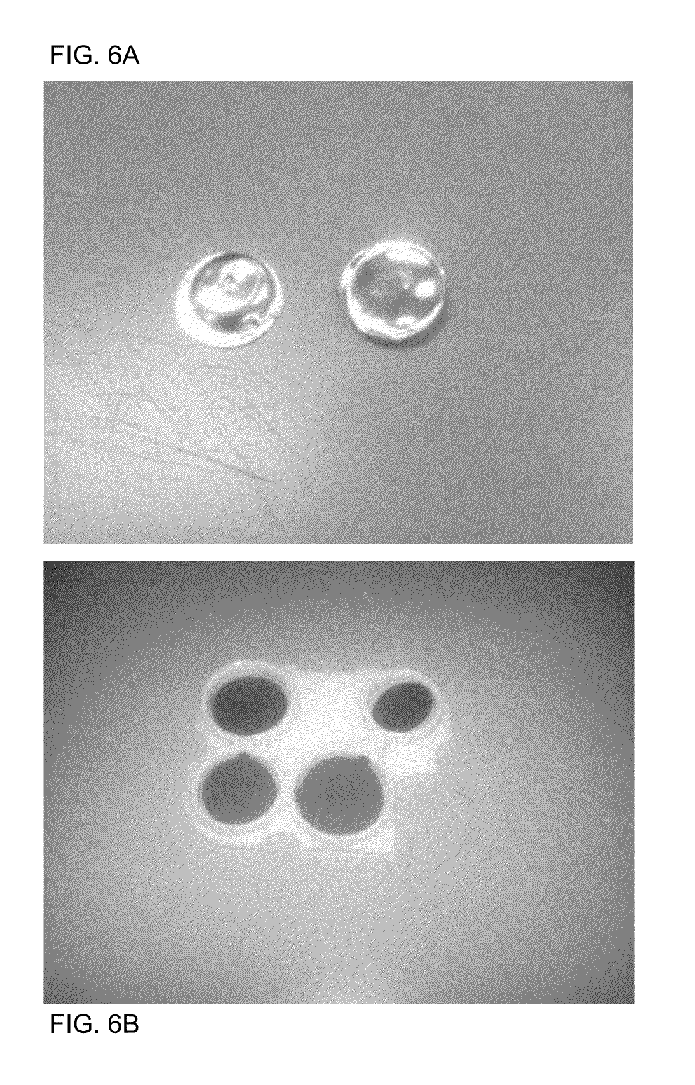

The spiral channel concept provided with the described apparatuses was tested using a different setup with components that mimicked the final design components (FIG. 5). As shown in FIG. 5, still frame images were captured from a video sequence of these experiments (from the underneath or bottom face perspective of a provided apparatus) and are shown FIG. 5. The image sequence starts with an empty main body connected to an unseen rupturable pack filled with food coloring (FIG. 5A). The rupturable pack is manually pushed with the thumb into a spike. The blister ruptures and the blue liquid begins to fill the initial spiral section (FIG. 5B). As time passes the liquid fills more of the spiral (FIG. 5C and FIG. 5D) until the contents of the blister are fully emptied (FIG. 5E). Note that the overflow port at the end of the spiral channel (rupturable pack overflow ports 4 in FIG. 3A) would become significant if the rupturable pack contained more liquid or the reagent pack used a shorter spiral frame (FIG. 5F). As shown, the plunger from the syringe (used to mimic a microfluidic device) is pulled back and the blue liquid is draw into the syringe from the center of the spiral.

Experiments conducted during the course of developing the described embodiments determined that both straight and spiral channels within the main body (straight channels 14 and spiral fluidic channels 16 shown in FIG. 3B) were important for directing fluid flow from a bursting rupturable pack and were important for providing a reliable reservoir stream for an attached microfluidic device. Such experiments demonstrated that main body designs having only simple large cavity spaces underneath the rupturable packs (instead of cavities connected with straight and spiral channels as shown in FIG. 3B) resulted in inadequate fluid pooling for microfluidic operation. Such experiments further demonstrated that the straight and spiral channels underneath the rupturable packs resulted in optimal fluid storage for microfluidic operation. Indeed, the spiral channels were shown to increase the volume of reagent for the microfluidic device without significantly increasing the footprint of the apparatus (main body) or microfluidic device. It was shown that the spiral or straight channels both provide a liquid column such that as liquid is drawn into an attached microfluidic device the liquid column gets pulled towards the microfluidic drain (e.g., the liquid reservoir remains in same location until the liquid is exhausted). This concept also differs from a single larger chamber concept because microfluidic devices tend to pull liquid or air in path of least resistance and leave a ring of liquid around a central air core when pulling external liquids into the card—especially as reservoirs become low on fluid. The described apparatuses having straight channel like features further provide methods to directly and quickly channel liquid directly to a chamber from a rupturable pack.

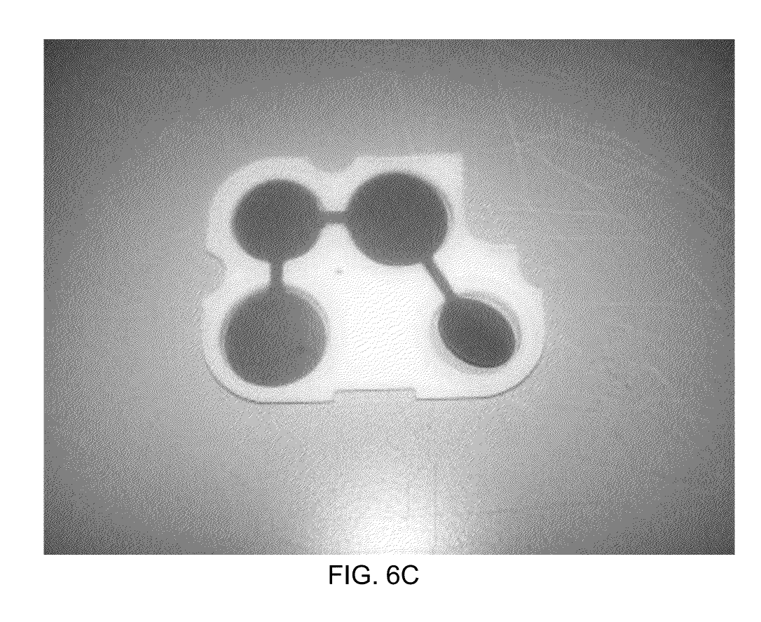

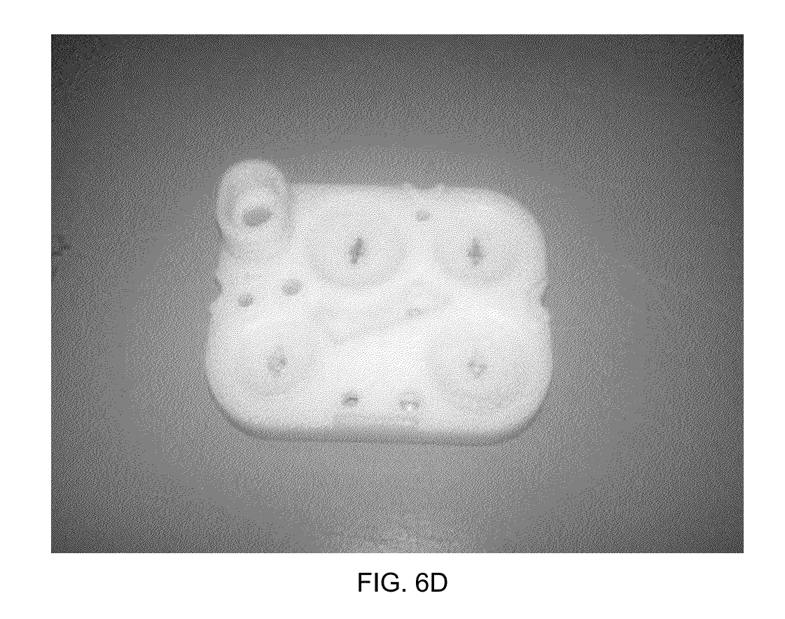

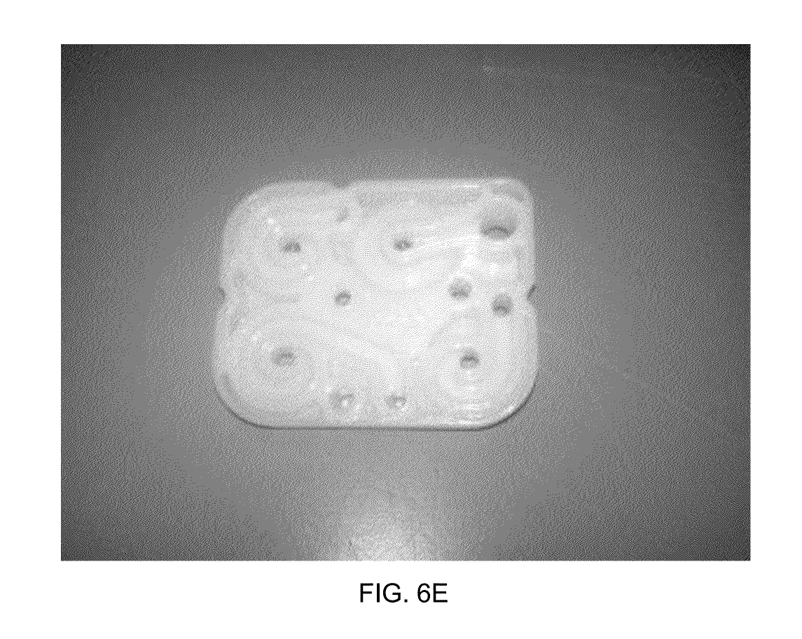

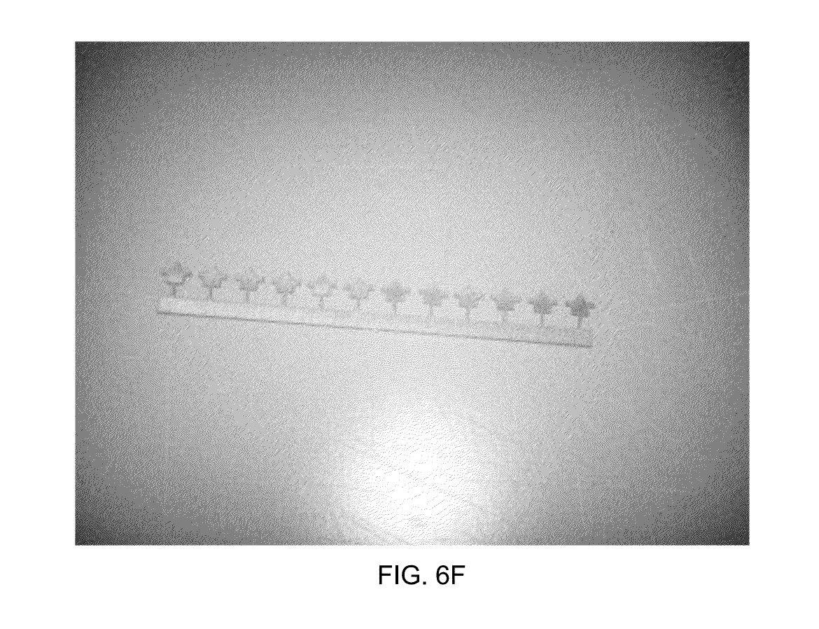

FIG. 6 presents photographs of some of the components of the apparatus. FIG. 6A shows rupturable pack (for a size reference the shown rupturable packs have the approximate diameter of a USD $0.25 quarter) containing approximately 500 ml of fluid. FIG. 6B shows a topside view of a 3D printed prototype of the top body piece with the inserted gasket piece. FIG. 6C shows a bottom side view of the top body piece with the inserted gasket piece (note that the gasket piece is a single component connected by the thin neck features) (note that the top body piece contains recess that allow for easy alignment and placement of the gasket piece). FIG. 6D shows top view of a 3D printed main body piece prototype. The sample/swab port is visible as the protrusion in the top left of the described apparatus. Metal barbs are insert in the top two reagent pack cavities and are left empty on the bottom two for comparison. FIG. 6E shows a view of the bottom of a 3D printed main body piece prototype. The straight and spiral channels along with via holes to the rupturable pack cavities are visible. FIG. 6F shows a water jet strip of metal barbs which are then twisted off and inserted into the apparatus.

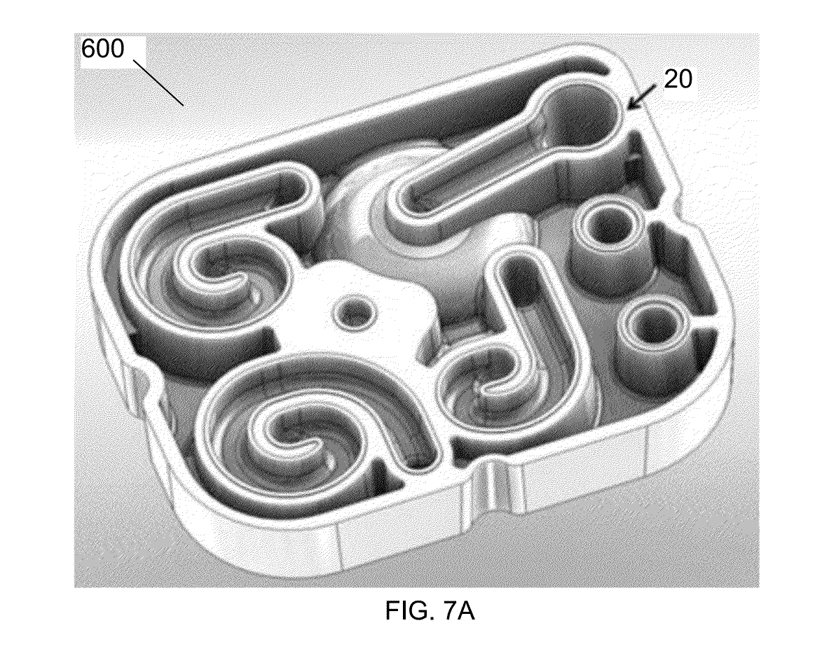

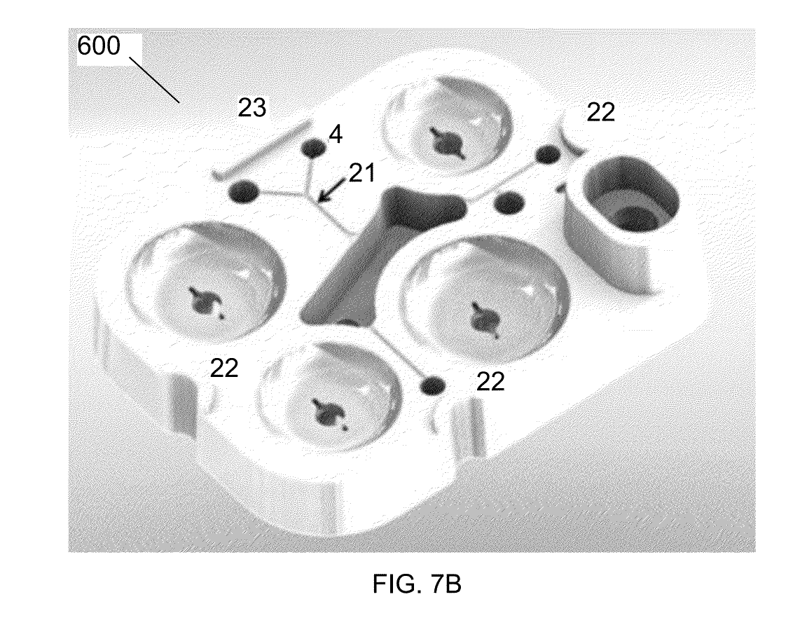

FIGS. 7A and 7B shows an additional main body 600 embodiment for the described apparatuses.

FIG. 7A shows a bottom side view of the main body 600 similar to the main body shown in FIGS. 2 and 3. As shown, the main body 600 further includes a raised ridge 20 that runs along the bottom straight and spiral channel perimeter. The raised ridge 20 serves to improve bonding of the main body 600 with a microfluidic device.

FIG. 7B shows a top side view of the main body 600 similar to the main body shown in FIGS. 2 and 3. As shown, the main body 600 has venting channels 21 that allow air to pass from the blister overflow output ports into the large waste area and finally escape out through the top piece. As shown, the previously separate external and internal alignment features in this main body 600 embodiment is combined into a single hybrid internal/external alignment feature 22. The curved indents on the external body are used to align to a protrusion on a microfluidic device. The raised extrusions that extend upwards from the main body 600 then function to align the top body piece of the apparatus to the main body piece. Additionally a new straight bar piece 23 is used to brace and align the top body piece and adhesive layers during assembly.

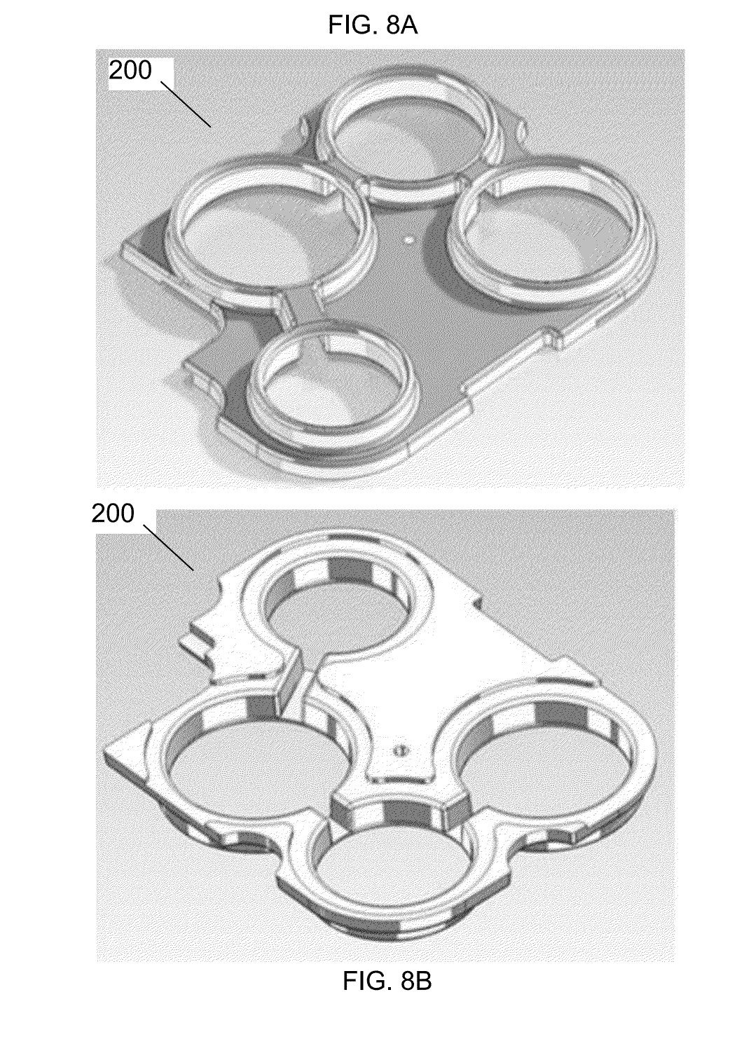

FIG. 8 shows a modified top piece 200 configured to fit the main body piece embodiment shown in FIG. 7B. FIG. 8A presents a schematic showing the top side of the top piece 200, and FIG. 8B shows the bottom side of the top piece 200. As shown in FIGS. 8A and 8B, the top piece 200 is designed as a coverslip, follows the contours of the main body shown in FIG. 7B, has recesses for the edges or lips of the rupturable packs, has channels to allow the gasket piece to fit inside, has alignment features for the adhesive layer and main body, and a venting hole.

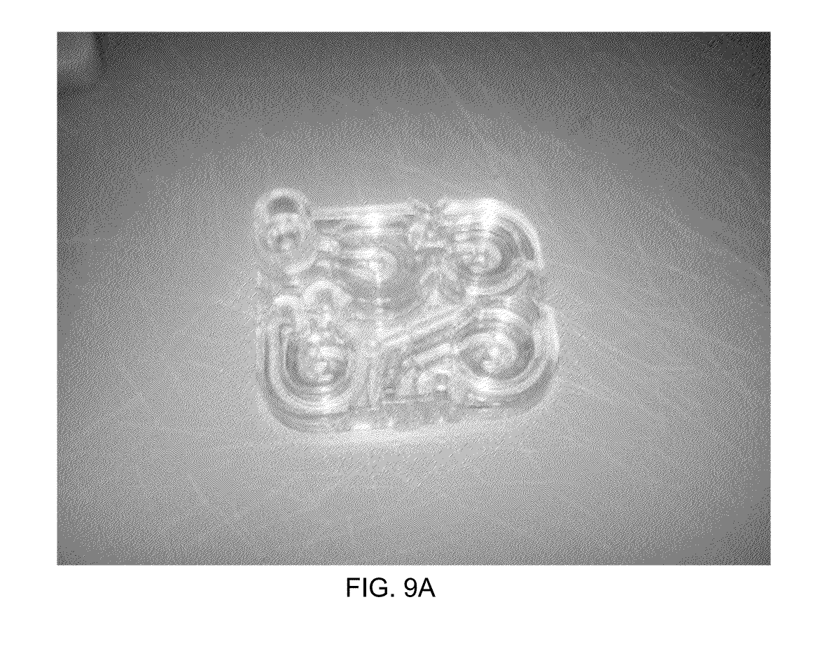

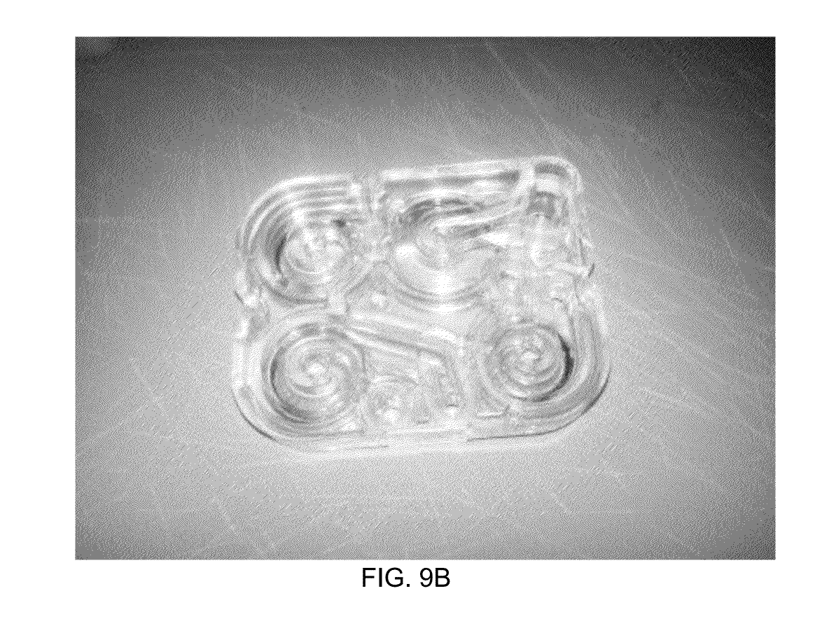

FIG. 9A provides top side photographs of the modified top piece 200 described in FIG. 8A. FIG. 9B provides bottom side photographs of the modified top piece 200 described in FIG. 8B.

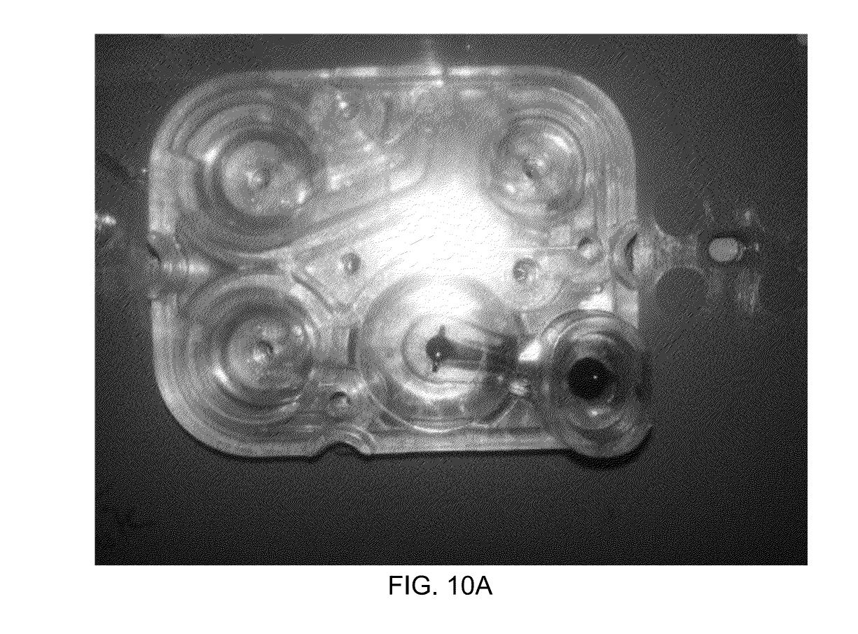

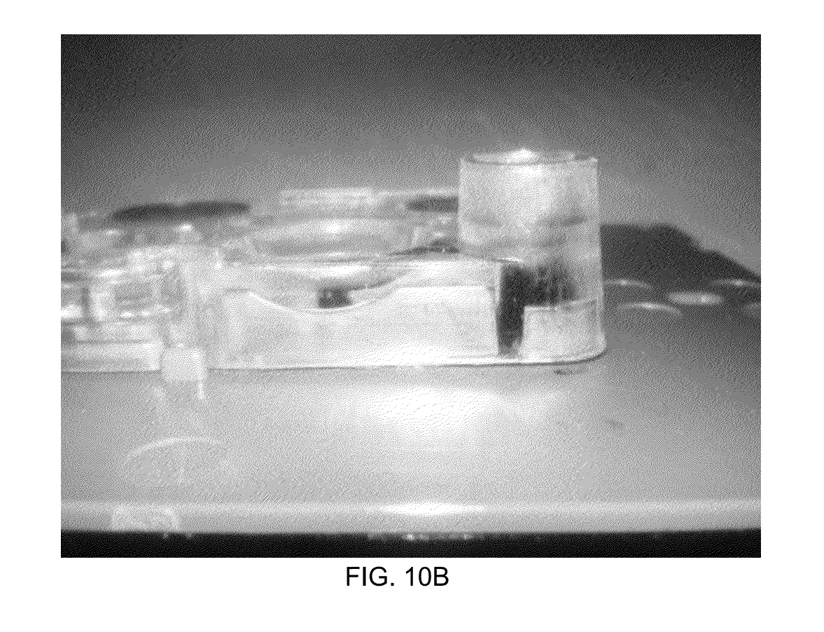

FIGS. 10A and 10B show injection molded embodiments of the main body with the bottom right straight channel filled with a dark dye. As shown, the dye stays in the straight channel and feeds and fills directly into the sample/swab port. The figures are representative images that show the apparatus demonstrates both the functionality and that the bonding to the microfluidic device can occur without leakage.

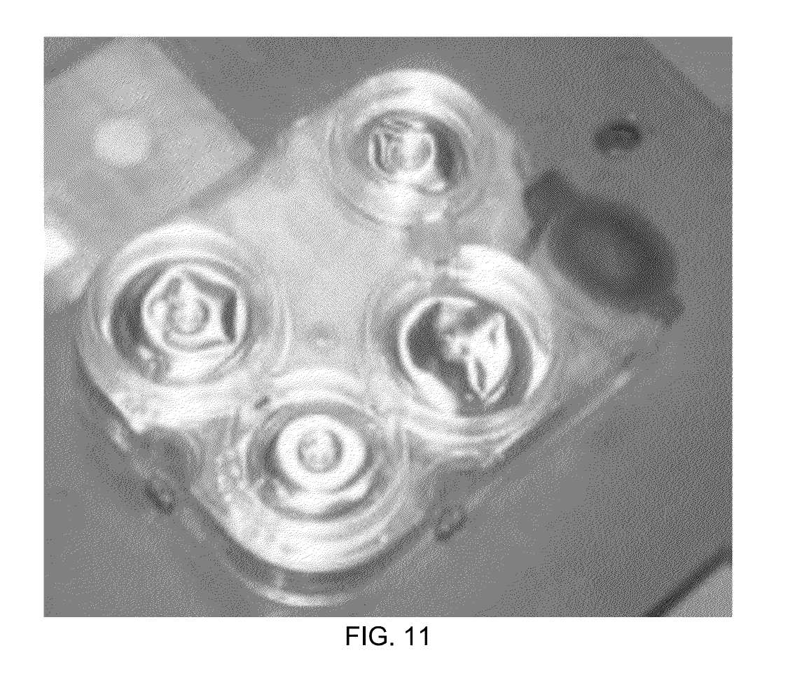

FIG. 11 provides a photograph of an assembled injection molded embodiment of a described apparatus. The gasket has been removed to show how the rupturable packs fit into the device. The lid/enclosure is the darker piece covering the sample/swab port. The alignment features of the apparatus are shown to match the alignment feature protrusions the stick up from the microfluidic card.

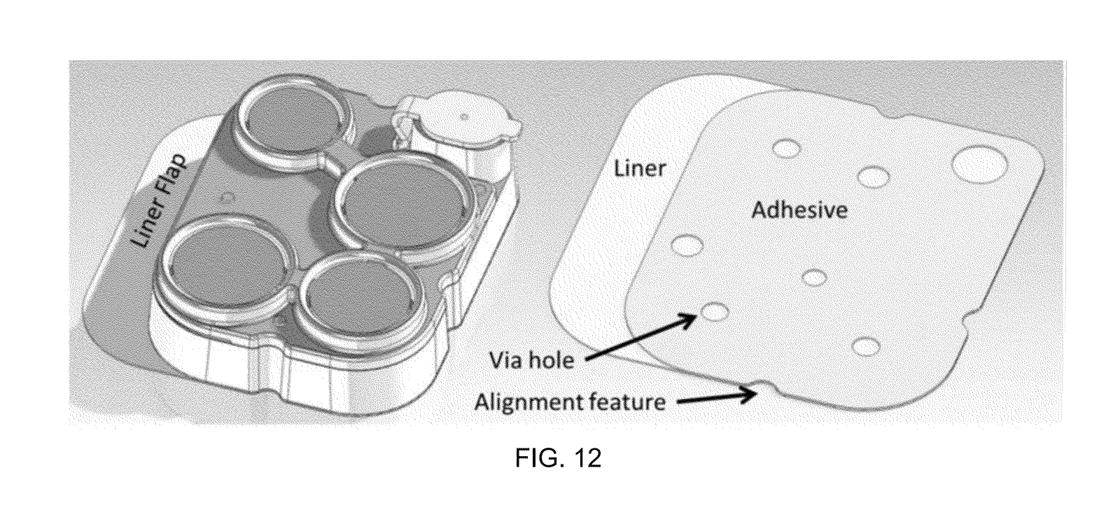

FIG. 12 shows an alternate embodiment for the bottom adhesive described in FIG. 2. As shown, a “peel and place” adhesive with built in alignment is provided. In such embodiments, a bottom adhesive layer is attached with an excess backside liner. As shown, the liner (white piece) is a material such that it easily peels away from the adhesive (green piece) while remaining bonded to the main body above. In some embodiments, the concept uses excess liner to create a flap that provides a grasping place for a user to peel away the liner material from the main body resulting in the reagent pack having exposed adhesive on its bottom face enabling it to easily bond with a microfluidic card. In some embodiments, the liner/adhesive system further incorporates alignment features for assembly onto the main body and microfluidic device. For example, in some embodiments, the adhesive layer has thereon via holes to allow fluid to pass to/from the main body into the microfluidic device. In some embodiments, the liner further serves as a barrier to hold dry reagents or membrane like materials within the main body. In some embodiments, the liner also incorporates similar via holes (e.g., for easier manufacturing). In some embodiments, so as to prevent potential outside contamination from entering the main body, the liner does not have via holes.

Embodiments incorporating the “peel and place” concept described in FIG. 12 allows for the reagent pack with sample/swab port to act as a separate modular component distinct from an accompanying microfluidic device. Indeed, such a design separates and simplifies the manufacturing process and creates an end product that facilitates separate storage conditions. For example, microfluidic cards without any reagents could be created by the thousands and stored at room temperature with very long shelf life whereas reagents (e.g., PCR master mix, enzymes, lysis buffer) typically have a short shelf life and must be kept refrigerated or exclusively use lyophilized reagents and di-water. Embodiments incorporating the “peel and place” concept described in FIG. 12 can be stored in a separate cold chain to extend overall product life and save storage space for point of care applications. For example, a user could simply obtain a microfluidic card in a box off the shelf and then remove such an embodiment (shown in FIG. 12) from refrigeration storage and peel and place the apparatus onto the microfluidic card for use. In some embodiments, the apparatus could be manufactured/assembled such that it is already attached with a microfluidic card.

In some embodiments, the main body includes stirring agents. The provided main body is not limited to particular types or kinds of stirring agents. In some embodiments, the stirring agents are miniature stir bars. The main body is not limited to having a particular number of stirring agents (e.g., 1, 2, 3, 5, 10, etc). The main body is not limited to having stirring agents at particular regions within the main body. Stirring agents within the main body serves to assist in the mixing of the liquid contents released from the rupturable packs within various regions of the main body. In some embodiments, the stirring agents are miniature stir bars. In some embodiments, the stirring agents serve to mix liquid released from the rupturable packs at the swab port (e.g., containing a swab having contacted a sample thereon). In some embodiments, the stirring agents serve to mix any liquid at any region of the main body. In some embodiments, the stirring agents serve to capture bead based elements within the main body. In some embodiments, the stirring agents serve to induce mixing of beads within an external microfluidic card. In some embodiments, the mixing with stirring agents occurs manually. In some embodiments, the mixing with stirring agents occurs automatically. In some embodiments, the mixing with stirring agents occurs either manually or automatically.

In some embodiments, the main body includes permanent or electromagnetic elements for purposes of interaction with a separate microfluidic card.

In some embodiments, the main body includes sonication elements within the main body. In some embodiments, sonication elements facilitate performing sonication within the apparatus. In some embodiments, sonication elements facilitate performing sonication within a separate microfluidic card (attached with the apparatus).

In some embodiments, the main body includes heaters for purposes of heating the liquid within the main body. In some embodiments, the main body includes heaters for purposes of heating the liquid within a separate microfluidic card (attached with the apparatus).

In certain embodiments, systems are provided which include the described apparatuses. For example, in some embodiments, systems having a described apparatus and a swab (e.g., a swab contained within a swab housing (e.g., a SecurSwab (Bode Technology) swab housing or any type or kind of variation of a SecurSwab (Bode Technology) swab housing)) are provided. In some embodiments, such systems further include a microfluidic card for attachment with the apparatus. In some embodiments, the microfluidic card is attached with the apparatus.

In certain embodiments, kits are provided which include such apparatuses. For example, in some embodiments, kits having a described apparatus, a swab (e.g., having thereon a sample), and a microfluidic card are provided.

The apparatus, systems, and kits described herein find use in any type of setting requiring the contacting of a desired liquid with a sample contained on a swab (e.g., a forensic setting, a food safety setting, a medical sampling setting, an environmental setting, a cosmetic setting, and/or an industrial cleaning setting) (e.g., any setting requiring the sterile use of swab having thereon any desired type of fluid). The apparatus, systems, and kits described herein find use in any type of setting requiring the contacting of a desired liquid with a sample contained on a swab for applications involving microfluidics (e.g., a forensic setting, a food safety setting, a medical sampling setting, an environmental setting, a cosmetic setting, and/or an industrial cleaning setting) (e.g., any setting requiring the sterile use of swab having thereon any desired type of fluid).

In some embodiments wherein the setting is a DNA forensic setting, the described apparatuses, systems, and/or kits are used to contact a desired fluid (e.g., sterile water) (e.g., DNA buffer (e.g., 10 mM tris-HCl)) with a sample contained on a swab contained within the apparatus (e.g., contained within the swab port), and subsequent delivery to a microfluidic card.

In some embodiments wherein the setting is an environmental setting, the described apparatuses, systems, and/or kits are used to sterilely apply a desired fluid (e.g., organic solvent) to a sample contained on a swab contained within the apparatus (e.g., contained within the swab port), and subsequent delivery to a microfluidic card.

As described above, the provided apparatuses, systems, kits, and methods represent significant improvements involving the contacting of a desired fluid to a sample contained on a swab. Indeed, the provided apparatuses, systems, kits, and methods solve the problem of how to interface swabs that are traditionally used in forensics, clinical applications, biowarfare, and analysis of explosives in microfluidic devices. It serves as a mechanism/interface to enable removal of manual labor intensive steps from the benchtop. Moreover, novel methods are provided to introduce liquid material over the swab. Samples are not limited to swabs and could be solid, liquid, or powder. Improved methods to envelop such samples with liquid prior to microfluidic operation via the described swab port within the main body are provided. Generally, this area has been vastly ignored in the microfluidic community and the provided embodiments address this community need.

The provided embodiments facilitate automated microfluidic sample preparation from multiple perspectives. For example, the provided embodiments present a user with a simple and universal sample type interface for the analysis of macroscopic samples. The provided embodiments present a user with a simple and universal sample type interface for the analysis of macroscopic samples configured to implement both liquid and solid samples.

The provided embodiments present a user with a simple and universal sample type interface wherein the samples are automatically archived inside the device for future analysis by other systems. The provided embodiments present a user with a simple and universal sample type interface wherein apparatus is modular in concept. The provided embodiments present a user with a simple and universal sample type interface wherein all waste products from the microfluidic device are stored in the device. The provided embodiments present a user with a simple and universal sample type interface wherein the sample preparation time is reduced. The provided embodiments present a user with a simple and universal sample type interface wherein rehydration of lyophilized/dry reagents occurs rapidly and without the use of a separate microfluidic system/plumbing. The provided embodiments present a user with a simple and universal sample type interface which simplify microfluidic device designs and reduces the internal plumbing required inside microfluidic devices to perform sample processing. The provided embodiments present a user with a simple and universal sample type interface which reduces the number of physical subcomponents used to make a microfluidic device into one simple device.

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the medical sciences are intended to be within the scope of the following claims.

We claim:

1. An apparatus for contacting a sample of interest with a fluid within a housing, comprising a swab port region configured to receive and contain a portion of a swab having thereon a sample of interest and one or more rupturable pack regions configured to receive and contain one or more rupturable packs containing fluid, wherein the apparatus further comprises spiral channels and/or straight channels connecting the swab port region and the rupturable pack regions for purposes of delivering fluid released in the rupturable pack cavity to the swab port region, wherein the apparatus further comprises one or more ports for releasing the liquid from the apparatus to an external device.

2. The apparatus of claim 1, wherein the swab port region has thereon a lid for sealing the swab port region upon receipt of a swab.

3. The apparatus of claim 1, wherein the apparatus further comprises overflow regions configured to retain excess fluid released through the rupturable pack regions.

4. The apparatus of claim 1, wherein the apparatus is configured for engagement with a microfluidic device.

5. The apparatus of claim 1, wherein the one or more ports for releasing the liquid from the apparatus to an external device are configured for delivering fluid having been contacted with the swab port region to a microfluidic device.

6. The apparatus of claim 1, wherein one or more of the swab port region, rupturable pack cavities, straight channels, and spiral channels contain lyophilized regents.

7. The apparatus of claim 1, wherein the bottom side of the apparatus has thereon a double-sided adhesive, wherein the apparatus is configured to adhesively engage with an external device via the double-sided adhesive.

8. The apparatus of claim 1, wherein the apparatus is engaged with an external device via ultrasonic welding.

9. The apparatus of claim 1, wherein the swab port has therein a filtration membrane.

10. The apparatus of claim 1, further comprising one or more of:
one or more stirring agents configured for manual or automatic mixing of liquid released into the apparatus,
electromagnetic elements,
sonication elements,
heating elements.

11. The apparatus of claim 1, wherein the apparatus is configured for automatic or manual bursting of rupturable packs positioned within the rupturable pack regions.

12. The apparatus of claim 1, wherein the wherein the one or more rupturable packs contain one or more fluids selected from the group consisting of lysis buffer, PCR master mix, wash buffer, elution buffer, and de-ionized water.

13. A system for contacting a sample of interest with a fluid within a housing, comprising an apparatus of claim 1, and one or more rupturable packs containing a fluid of interest.

14. The system of claim 13, wherein the one or more rupturable packs contain one or more fluids selected from the group consisting of lysis buffer, PCR master mix, wash buffer, elution buffer, and de-ionized water.

15. The system of claim 13, wherein the one or more rupturable packs are positioned within the one or more rupturable pack regions.

16. The system of claim 13, further comprising a microfluidic device.

17. The system of claim 16, wherein the microfluidic device is engaged with the apparatus.

18. A method of contacting a fluid with a sample, comprising rupturing a rupturable pack containing a fluid positioned within the apparatus of claim 1, wherein the rupturing results in a flow of the fluid through the rupturable pack cavity into one or more of the straight and spiral channels and into the swab port region, wherein the flow of fluid into the swab port region results in contact of the fluid with a sample contained on a swab positioned within the swab port region.

19. The method of claim 18, further comprising releasing the fluid contacted with the sample from the apparatus to a microfluidic device engaged with the apparatus.

20. The method of claim 18, wherein the one or more rupturable packs contain one or more fluids selected from the group consisting of lysis buffer, PCR master mix, wash buffer, elution buffer, and de-ionized water.
